(19) United States
(12) Patent Application Publication
(10) Pub. No.: US 2009/0237522 A1
(43) Pub. Date: Sep. 24, 2009

(54) METHOD FOR CONTROLLING DIGITAL PICTURE FRAME AND DIGITAL PICTURE FRAME THEREOF

(76) Inventor: Shu-Yi Lin, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/406,062

(22) Filed: Mar. 17, 2009

(30) Foreign Application Priority Data
Mar. 18, 2008 (TW) 097109466

(51) Int. Cl. H04N 5/228; G06K 9/68; H04N 7/00; H04N 5/222

(52) U.S. Cl. 348/222.1; 382/218; 386/46; 348/333.01; 348/E05.022; 348/E05.031

(57) ABSTRACT

A method for controlling a digital picture frame includes the following steps of: establishing an image data corresponding to a folder stored in the digital picture frame, connecting a storage device to the digital picture frame, capturing an image by the digital picture frame, comparing the image with the image data to generate a comparison result by the digital picture frame, and determining whether to provide an option of transmitting data between the storage device and the folder according to the comparison result by the digital picture frame.

### BACKGROUND OF THE INVENTION

1. Field of the Invention

The invention relates to a method for controlling a digital picture frame and the digital picture frame thereof and, more particularly, to a method for controlling a digital picture frame based on image recognition and the digital picture frame thereof.

2. Description of the Prior Art

As technology advanced, various digital electronic products have been developed to replace traditional supplies. For example, a traditional picture frame has been replaced by a digital picture frame.

In general, compared with the traditional picture frame, the digital picture frame has an advantage of displaying image files in electronic manner instead of manually replacing real pictures in the picture frame. That is to say, a user can establish a folder in a storage device of the digital picture frame for storing an amount of image files, and the image files can be displayed on a display device of the digital picture frame. When the user wants to replace the image being displayed by the digital picture frame, he or she only needs to operate a control interface of the digital picture frame, and then the displayed image will be replaced by a selected image. Accordingly, not only the time of replacing pictures can be reduced, but the expense of printing real pictures can be saved.

Most of the present digital picture frames are designed for single user rather than multiple users (e.g. family members). Therefore, when a user buys a digital picture frame for his or her family members, he or she has to establish individual folders in the storage device of the digital picture frame for the family members correspondingly. Then, each family member can store his or her image files to the corresponding folder. However, if the user wants to control the digital picture frame to change the displayed image from current folder to another, such as from mother's folder to father's folder, or access a specific file, he or she still has to manually operate the control interface of the digital picture frame to execute follow-up actions such as playing images or accessing files. In other words, due to the unfriendly interface, the operation of the conventional digital picture frame is complicated and inconvenient for the user, such that the desired image cannot be displayed instantaneously.

### SUMMARY OF THE INVENTION

The invention provides a method for controlling a digital picture frame based on image recognition. The method comprises the following steps of establishing an image data corresponding to a folder stored in the digital picture frame, connecting a storage device to the digital picture frame, capturing an image by the digital picture frame, comparing the image with the image data so as to generate a comparison result by the digital picture frame, and determining whether to provide an option of transmitting data between the storage device and the folder according to the comparison result by the digital picture frame.

The invention further provides a digital picture frame capable of recognizing image. The digital picture frame comprises a first storage device, an input/output device, an image capturing device, a comparing means, and a controlling means. The first storage device is used for storing an image data corresponding to a folder. The input/output device is used for selectively connecting a second storage device. The image capturing device is used for capturing an image when the second storage device is connected to the input/output device. The comparing means is used for comparing the image with the image data to generate a comparison result when the second storage device is connected to the input/output device. The controlling means is used for determining whether to provide an option of transmitting data between the folder and the second storage device according to the comparison result.

The invention further provides a method for controlling a digital picture frame to play audio/video message based on image recognition. The method comprises the following steps of recording an audio/video message into the digital picture frame wherein the audio/video message is corresponding to an image data, capturing an image by the digital picture frame, comparing the image with the image data to generate a comparison result by the digital picture frame, and determining whether to play the audio/video message according to the comparison result by the digital picture frame.

The invention further provides a digital picture frame for playing audio/video message. The digital picture frame comprises an image capturing device, a storage device, a comparing means, a play device, and a controlling means. The image capturing device is used for capturing an image and recording an audio/video message corresponding to an image data. The storage device is used for storing the audio/video message and the image data. The comparing means is used for comparing the image with the image data to generate a comparison result. The play device is used for selectively playing the audio/video message. The controlling means is used for controlling the play device whether to play the audio/video message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a digital picture frame according to a first embodiment of the present invention.

FIG. 2 is a flowchart illustrating a method for controlling the digital picture frame based on image recognition according to the first embodiment of the present invention.

FIG. 3 is a functional block diagram illustrating a digital picture frame according to a second embodiment of the present invention.

FIG. 4 is a flowchart illustrating a method for controlling the digital picture frame to play audio/video message based on image recognition according to the second embodiment of the present invention.

### DETAILED DESCRIPTION

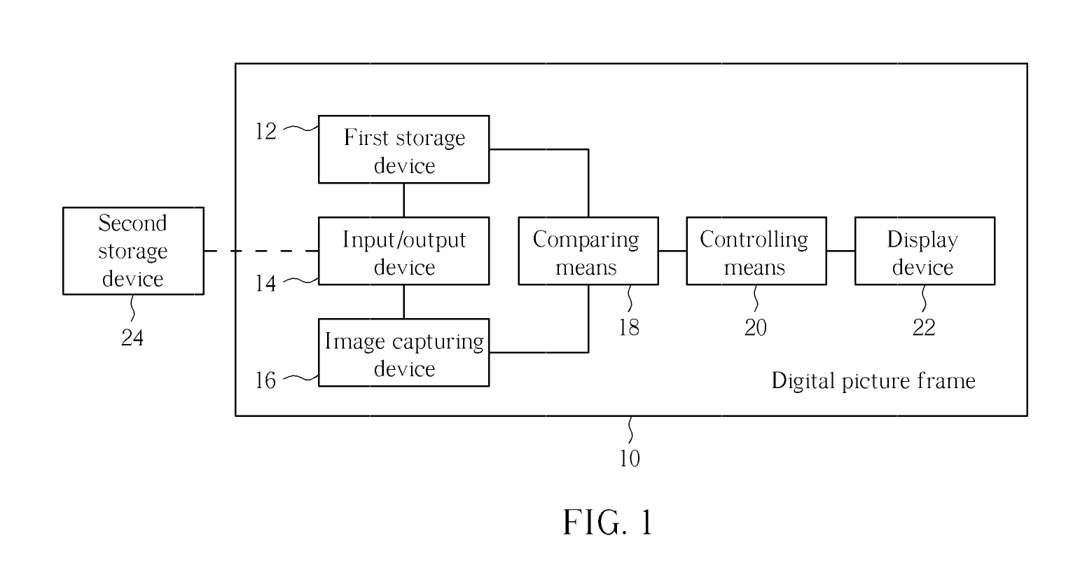

Referring to FIG. 1, FIG. 1 is a functional block diagram illustrating a digital picture frame 10 according to a first embodiment of the present invention. The digital picture frame 10 comprises a first storage device 12, an input/output device 14, an image capturing device 16, a comparing means 18, a controlling means 20, and a display device 22. The first storage device 12 is used for storing an image data corresponding to a folder. The input/output device 14 is used for selectively connecting a second storage device 24. The image capturing device 16 is used for capturing an image when the second storage device 24 is connected to the input/output device 14. The comparing means 18 is used for comparing the image with the image data so as to generate a comparison result when the second storage device 24 is connected to the input/output device 14. The controlling means 20 is used for determining whether to control the display device 22 to provide an option of transmitting data between the folder and the second storage device 24 according to the comparison result. Furthermore, the controlling means 20 can control the display device 22 to play an audio/video file stored in the folder when the comparison result is that the image fits in with the image data. The image capturing device 16 is preferably a digital video camera, and the input/output device 14 is preferably a universal serial bus (USB).

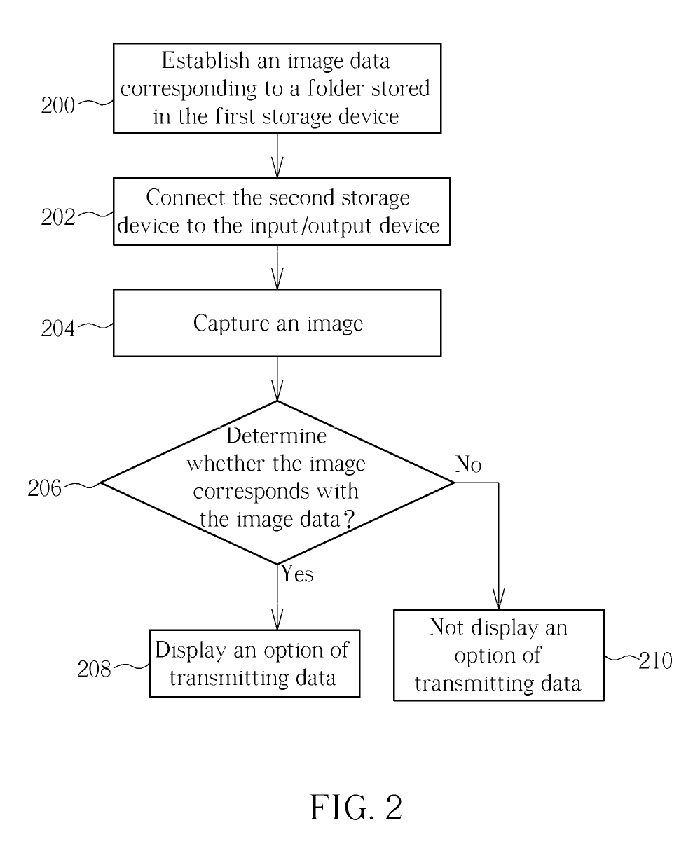

Referring to FIG. 2, FIG. 2 is a flowchart illustrating a method for controlling the digital picture frame 10 based on image recognition result. The method of the invention comprises the following steps.

Step 200: Establish an image data corresponding to a folder stored in the first storage device 12.

Step 202: Connect the second storage device 24 to the input/output device 14.

Step 204: Capture an image by the image capturing device 16.

Step 206: Compare the image with the image data by the comparing means 18, so as to determine whether the image corresponds with the image data, and execute Step 208 if the image corresponds with the image data, otherwise, execute Step 210.

Step 208: Control the display device 22 by the controlling means 20 to display an option of transmitting data between the second storage device 24 and the folder.

Step 210: Control the display device 22 by the controlling means 20 not to display the option of transmitting data between the second storage device 24 and the folder.

The steps shown in FIG. 2 will be depicted in detail as follows. First of all, in the Step 200, when a user wants to make the digital picture frame 10 actively recognize his or her image and then execute corresponding processes, he or she has to utilize the image capturing device 16 of the digital picture frame 10 to capture an image file corresponding to himself or herself. Then, the user has to associate the image file with a specific folder corresponding to him or her, such as a folder marked as number 1.

Afterwards, if someone connects the second storage device 24 (e.g. a flash drive or a memory card) to the input/output device 14 (Step 202), the image capturing device 16 captures an image of the user (Step 204), who is using the digital picture frame 10. After the image capturing device 16 captures the image, the comparing means 18 compares the image with the image data stored in the first storage device 12 and then determines whether the image corresponds with the image data (Step 206).

If the image corresponds with the image data, i.e. the current user is the aforesaid user corresponding to the specific folder, the controlling means 20 controls the display device 22 to display the option of transmitting data between the folder and the second storage device 24 (Step 208). For example, the option may be displayed as “store data to number 1 folder or not?”, “read data from number 1 folder or not?”, “read/store data from/to number 1 folder?”, and so on. At this time, the user can determine whether the data should be transmitted between the folder and the second storage device 24. For example, the user can press a function key on the digital picture frame 10 to transmit data from the second storage device 24 to the folder or from the folder to the second storage device 24.

On the other hand, if the image does not correspond with the image data, i.e. the current user is not the aforesaid user corresponding to the specific folder, the controlling means 20 controls the display device 22 not to display the option of transmitting data between the folder and the second storage device 24 (Step 210). That is to say, the user, who is using the digital picture frame 10, cannot see the aforesaid option. Accordingly, the data transmitting interface of the digital picture frame 10 is more friendly than the prior art and the security of transmitting data can be further ensured.

Furthermore, when the image corresponds with the image data, the display device 22 can be controlled to play an audio/video file, such as a picture of daily life, stored in the folder. In the first embodiment, it should be noted that the number of the image file captured by the image capturing device 16 is not limited to one. In other words, the image capturing device 16 can be used to capture a plurality of image files corresponding to a plurality of users, and a plurality of folders corresponding to the plurality of users can be established in the first storage device 12. Accordingly, by using the image capturing device 16 and the comparing means 18, the digital picture frame 10 can provide functions of data transmitting and image display for different users each of which corresponding to a specific folder.

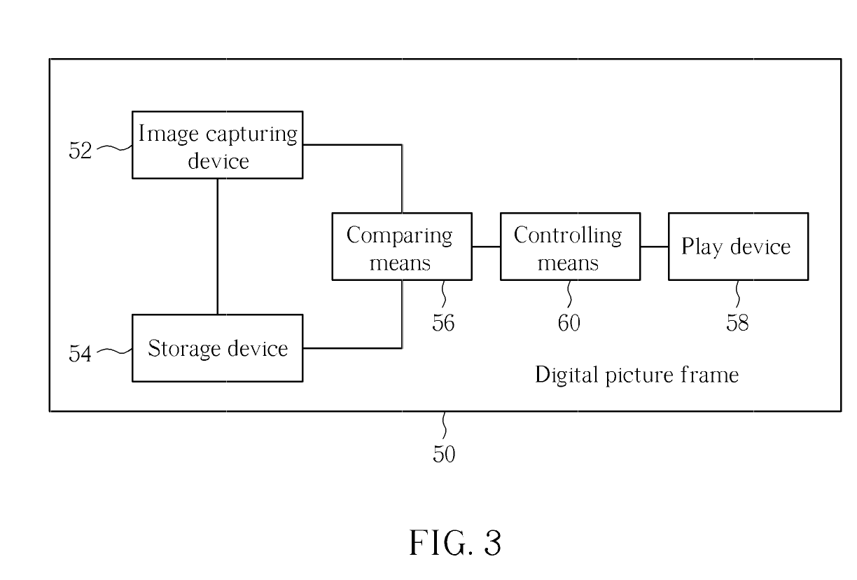

Referring to FIG. 3, FIG. 3 is a functional block diagram illustrating a digital picture frame 50 according to a second embodiment of the present invention. The digital picture frame 50 comprises an image capturing device 52, a storage device 54, a comparing means 56, a play device 58, and a controlling means 60. The image capturing device 52 is used for capturing an image and recording an audio/video message corresponding to an image data. The storage device 54 is used for storing the audio/video message and the image data. The comparing means 56 is used for comparing the image with the image data to generate a comparison result. The play device 58 is used for selectively playing the audio/video message. The controlling means 60 is used for controlling the play device 58 whether to play the audio/video message according to the comparison result. Furthermore, the controlling means 60 can control the play device 58 to play an option for determining whether to delete the audio/video message after the play device 58 plays the audio/video message. The image capturing device 52 is preferably a digital video camera, and the play device 58 is preferably a video play device (e.g. screen) or an audio play device (e.g. speaker).

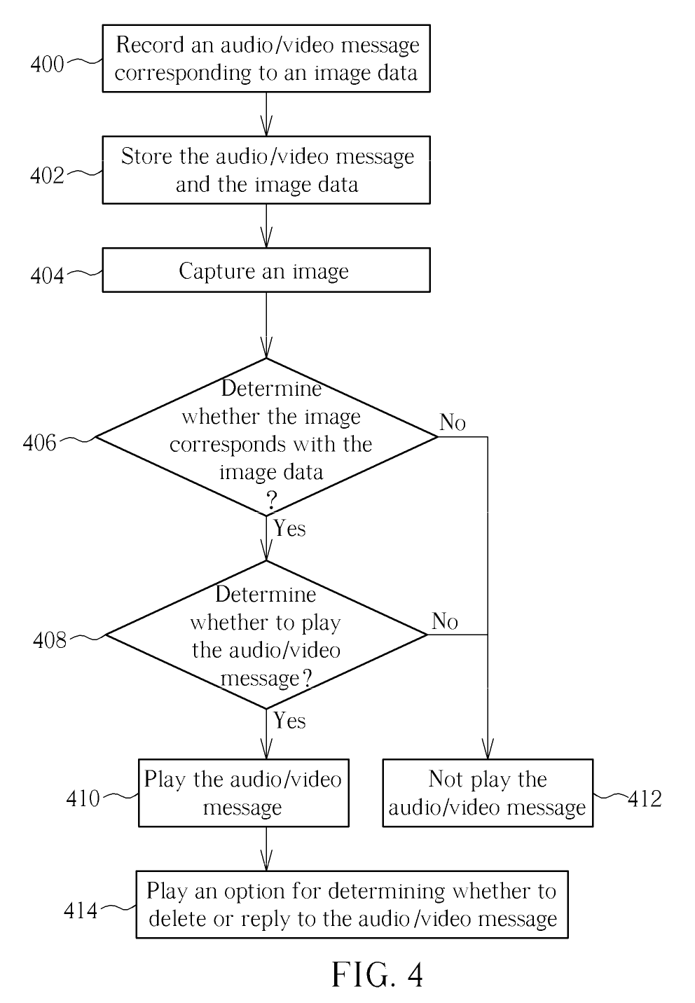

Referring to FIG. 4, FIG. 4 is a flowchart illustrating a method for controlling the digital picture frame 50 to play audio/video message based on image recognition according to the second embodiment of the present invention. The method of the invention comprises the following steps.

Step 400: Record an audio/video message corresponding to an image data by the image capturing device 52.

Step 402: Store the audio/video message and the image data in the storage device 54.

Step 404: Capture an image by the image capturing device 52.

Step 406: Compare the image with the image data by the comparing means 56, so as to determine whether the image corresponds with the image data, and execute Step 408 if the image corresponds with the image data, otherwise, execute Step 412.

Step 408: Determine whether to play the audio/video message and execute Step 410 if the audio/video message is played, otherwise, execute Step 412.

Step 410: Control the play device 58 to play the audio/video message by the controlling means 60 and execute Step 414.

Step 412: Control the play device 58 not to play the audio/video message by the controlling means 60.

Step 414: Control the play device 58 to play an option for determining whether to delete or reply to the audio/video message by the controlling means 60.

The steps shown in FIG. 4 will be depicted in detail in the following. First of all, in the Step 400, when a user wants to utilize the digital picture frame 50 to leave another user a message, he or she has to use the image capturing device 52 of the digital picture frame 50 to record an audio/video message corresponding to a target. Then, the user has to store the audio/video message and an image data corresponding to the designated target into the storage device 54 (Step 402). For example, if there are four image data corresponding to four users A, B, C and D stored in the digital picture frame 50, and the user A utilizes the digital picture frame 50 to leave a message, the digital picture frame 50 will show the image data of the four users A, B, C and D for the user A to select the target for leaving the message. The user A can leave the message for the user B, the users B and C, or the users B, C and D. After the user A selects the target, the digital picture frame 50 will start to record the audio/video message. Furthermore, in another embodiment, the user A can also select his or her own image data and leave himself or herself a message.

Afterwards, when a user gets close to the digital picture frame 50 within a specific range, the image capturing device 52 will capture an image corresponding to the user (Step 404). After capturing the image by the image capturing device 52, the comparing means 56 compares the image with the image data stored in the storage device 54 and determines whether the image corresponds with the image data (Step 406). In other words, the comparing means 56 is capable of determining whether the user close to the digital picture frame 50 is the designated target. If the image corresponds with the image data, i.e. the user close to the digital picture frame 50 is the designated target, the controlling means 60 will control the play device 58 to play an option for determining whether to play the audio/video message. For example, the option may be displayed or sounded as “read the message or not?”. At this time, the user, i.e. the designated target, can determine whether to read the audio/video message (Step 408). For example, the user can press a function key on the digital picture frame 50 to read the audio/video message, and then the controlling means 60 will control the play device 58 to play the audio/video message (Step 410). Similarly, the user can also press another function key on the digital picture frame 50 to ignore the audio/video message, and then the controlling means 60 will control the play device 58 not to play the audio/video message (Step 412). At the same time, the controlling means 60 can control the play device 58 to randomly play image files stored in the storage device 54 or immediately enter “sleep mode”. The follow-up control process depends on practical applications. It should be noted that the function of the controlling means 60 is not limited to the aforesaid manner when the captured image corresponds with the image data. In other words, the controlling means 60 can also control the play device 58 to directly play the audio/video message when the captured image corresponds to the image data, instead of playing the option for determining whether to play the audio/video message.

On the other hand, if the captured image does not correspond to the image data, i.e. a user close to the digital picture frame 50 is not the designated target, the control means 60 will also control the play device 58 not to play the audio/video message. That is to say, the user close to the digital picture frame 50 cannot see the aforesaid option. Accordingly, the digital picture frame 50 of the invention provides a friendly interface for selectively playing audio/video message and the security of playing audio/video message can be further ensured. Furthermore, after the play device 58 plays the audio/video message, the controlling means 60 will control the play device 58 to play an option for determining whether to delete or reply to the audio/video message (Step 414), such as “delete the message?” or “reply to the message?”, so as to remind the user to determine whether to delete or reply to the audio/video message.

In addition, for example, there are three users A, B and C using the digital picture frame 50 to leave messages, wherein the user A leaves the user B a message, the user B leaves the user C a message, and the user C leaves himself or herself a message. When the user C gets close to the digital picture frame 50, the digital picture frame 50 may play the messages left by the users B and C randomly, in record order, or in the priority of each message. In another situation, for example, there are three users D, E and F using the digital picture frame 50 to leave messages, wherein the user D leaves the user E a message, the user E leaves the user F a message, and the user F leaves the user D a message. When the users D and E get close to the digital picture frame 50 at the same time, the digital picture frame 50 may play the messages left by the users F and D randomly, in record order, or in the priority of each message.

In the prior art, a user has to manually operate the interface on a traditional digital picture frame to access files stored in a specific folder or play a specific image. However, the invention integrates a digital picture frame with an image capturing device to recognize a user who is using the digital picture frame or within a specific range from the digital picture frame. After recognizing the user, the digital picture frame will transmit data between specific folders, play a specific audio/video message, and so on. Accordingly, the user can enjoy the personal service without manual operation while using the digital picture frame of the invention. Furthermore, even if there are multiple users, the invention can also utilizing the aforesaid image capturing device and comparing means to transmit data between different folders and play images correspondingly.

Those skilled in the art will readily observe that numerous modifications and alterations of the device and method may be made while retaining the teachings of the invention.

What is claimed is:

1. A method for controlling a digital picture frame based on image recognition, the method comprising:
establishing an image data corresponding to a folder stored in the digital picture frame;
connecting a storage device to the digital picture frame;
capturing an image by the digital picture frame;
comparing the image with the image data so as to generate a comparison result by the digital picture frame; and
determining whether to provide an option of transmitting data between the storage device and the folder according to the comparison result by the digital picture frame.

2. The method of claim 1, further comprising determining whether to play an audio/video file stored in the folder according to the comparison result by the digital picture frame.

3. The method of claim 1, wherein the determining step comprises providing the option of transmitting data between the storage device and the folder by the digital picture frame when the comparison result is that the image corresponds with the image data.

4. The method of claim 1, wherein the determining step comprises disabling the digital picture frame from providing the option of transmitting data between the storage device and the folder when the comparison result is that the image does not correspond with the image data.

5. A digital picture frame capable of recognizing image comprising:
a first storage device for storing an image data corresponding to a folder;
an input/output device for selectively connecting a second storage device;
an image capturing device for capturing an image when the second storage device is connected to the input/output device;
a comparing means for comparing the image with the image data to generate a comparison result when the second storage device is connected to the input/output device; and
a controlling means for determining whether to provide an option of transmitting data between the folder and the second storage device according to the comparison result.

6. The digital picture frame of claim 5, further comprising a display device for playing an audio/video file stored in the folder when the comparison result is that the image corresponds with the image data.

7. The digital picture frame of claim 6, wherein the controlling means controls the display device to display the option of transmitting data between the folder and the second storage device when the comparison result is that the image corresponds with the image data.

8. The digital picture frame of claim 5, wherein the image capturing device is a digital video camera.

9. The digital picture frame of claim 5, wherein the input/output device is a universal serial bus.

10. A method for controlling a digital picture frame to play audio/video message based on image recognition, the method comprising:
recording an audio/video message into the digital picture frame, the audio/video message being corresponding to an image data;
capturing an image by the digital picture frame;
comparing the image with the image data to generate a comparison result by the digital picture frame; and
determining whether to play the audio/video message according to the comparison result by the digital picture frame.

11. The method of claim 10, wherein the determining step comprises playing the audio/video message by the digital picture frame when the comparison result is that the image corresponds with the image data.

12. The method of claim 10, wherein the determining step comprises disabling the digital picture frame from playing the audio/video message when the comparison result is that the image does not correspond with the image data.

13. The method of claim 10, wherein the determining step comprises providing an option for determining whether to play the audio/video message by the digital picture frame when the comparison result is that the image corresponds with the image data.

14. The method of claim 10, further comprising providing an option for determining whether to delete the audio/video message after the digital picture frame plays the audio/video.

15. The method of claim 10, further comprising providing an option for determining whether to reply to the audio/video message after the digital picture frame plays the audio/video.

16. A digital picture frame for playing audio/video message comprising:
an image capturing device for capturing an image and recording an audio/video message corresponding to an image data;
a storage device for storing the audio/video message and the image data;
a comparing means for comparing the image with the image data to generate a comparison result;
a play device for selectively playing the audio/video message; and
a controlling means for controlling the play device whether to play the audio/video message according to the comparison result.

17. The digital picture frame of claim 16, wherein the controlling means controls the play device to play the audio/video message when the comparison result is that the image corresponds with the image data.

18. The digital picture frame of claim 16, wherein the controlling means controls the play device to play an option for determining whether to play the audio/video message when the comparison result is that the image corresponds with the image data.

19. The digital picture frame of claim 16, wherein the controlling means controls the play device to play an option for determining whether to delete the audio/video message after the play device plays the audio/video message.

20. The digital picture frame of claim 16, wherein the controlling means controls the play device to play an option for determining whether to reply to the audio/video message after the play device plays the audio/video message.

21. The digital picture frame of claim 16, wherein the play device is a video play device.

22. The digital picture frame of claim 16, wherein the play device is an audio play device.
